(19) United States
(12) Patent Application Publication
(10) Pub. No.: US 2024/0094418 A1
(43) Pub. Date: Mar. 21, 2024

(54) SELECTION METHOD OF ARRAY LENGTH OF OBSERVATION SYSTEM

(71) Applicant: Ocean University of China, Qingdao City (CN)

(72) Inventors: Huaishan LIU, Qingdao City (CN); Mingxin ZHAO, Qingdao City (CN); Yuzhao LIN, Qingdao City (CN); Linfei WANG, Qingdao City (CN); Lei XING, Qingdao City (CN); Yanxin YIN, Qingdao City (CN)

(21) Appl. No.: 18/547,620

(22) PCT Filed: Jun. 16, 2022
(86) PCT No.: PCT/CN2022/099062

§ 371 Date: Aug. 23, 2023

(30) Foreign Application Priority Data
Apr. 23, 2022 (CN) 202210431768.9

(51) Int. Cl. G01V 1/28; G01V 1/137; G01V 1/38

(52) U.S. Cl. CPC G01V 1/28; G01V 1/137; G01V 1/3843

(57) ABSTRACT

The present invention provides a selection method of array length of observation system, comprising: step S101: obtaining a seismic response equation for any point on ground based on wavefield propagation theory; step S102: determining at least one selection criterion of an optimum array length considering different factors according to the seismic response equation; step S103: obtaining the array lengths considering the different factors respectively according to the at least one selection criterion of the optimum array length; and step S104: integrating the array lengths considering the different factors and determining that the optimum array length is \sqrt{2} times the depth of the destination layer. Compared with conventional array length calculation method the demonstration method of array length as proposed in the present invention has the advantages of higher accuracy and applicability for destination layers. It also has important significance in high resolution, high signal-to-noise ratio three-dimensional marine seismic explorations.

### TECHNICAL FIELD

The present invention relates to the technical field of field geological investigation and oil and gas resources prospection, and especially to a selection method of array length of observation system.

### BACKGROUND TECHNOLOGY

In field geological investigation and oil and gas resource prospection, the selection of parameters of the observation system is critical to high-quality imaging of target stara, and the selection of a reasonable array length is especially important for imaging of complex structure areas such as buried hills, depression, and overthrust nappe. With the deepening development of oil and gas resources into medium and deep layers, complex levels of seismic geological conditions are increased, correspondingly requirements on seismic acquisition accuracy and resolution are increased, accurate determination of array lengths of observation systems have gained more and more concern. When the array length is not big enough, efficient information may be lost; when the array length is too big, due to influence of normal moveout correction, advantageous main frequency is reduced, and more noises may be received. Consequently, quality of images may be not high enough. Conventionally selection of the array lengths of observation systems is based on horizontal stacking theories, and the premise of this method is to suppose that the subsurface is horizontally layered media. When used to explore dual-complex areas, wavefield may generate severe distortion. Seismic forward modeling for geological targets is an effective method to solve the above problems, mainly divided into forward modeling based on ray theory and forward modeling based on wave equation theory, and the above two technologies still have shortcomings in calculation accuracy and efficiency. Targeting the above calculation problems, seismic wavebeam theory represented by Gaussian beam has been developed. The seismic wave beam theory has features of both kinematics and mechanics. It can overcome the dead spot of rays to a certain degree, improve forward illumination accuracy, possess simultaneously high efficiency and flexibility, and can be adapted to complex geological conditions and seismic acquisition systems. However, there are still problems with the present method, for example, this method has no universality in parameter optimization and attribute evaluation.

In summary, selection methods and techniques of the available array lengths of observation systems are complex and have an array length deficiency in engineering and universality.

### SUMMARY OF INVENTION

The purpose of the present invention is to provide a selection method for the array length of the observation system based on wavefield propagation theory, and the proposed method is simpler and more universal.

A selection method of the array length of the observation system, comprising the following steps:

Step S101: obtaining a seismic response equation for any point on ground based on the wavefield propagation theory;

Step S102: determining at least one selection criterion of an optimum array length considering different factors according to the seismic response equation;

Wherein the different factors comprise: a depth of a destination layer, velocity analysis accuracy, normal moveout correction, reflected energy and amplitude variations with offset (AVO) accuracy;

Step S103: obtaining the array lengths considering the different factors respectively according to the at least one selection criterion of the optimum array length; and

Step S104: integrating the array lengths considering the different factors and determining that the optimum array length is \sqrt{2} times the depth of the destination layer. Further, the selection method of array length of observation system, wherein the step S101 comprises:

Step 1): given that seismic waves are excited in seawater by air guns, and are transmitted to a receiving tugboat after being reflected or diffracted by an underground point, conducting quantitative analysis of seismic response of the underground point with seismic diffraction theory, then:

Seismic response of the underground in a horizontal direction is:

$$ϕ ( x , y , z , t ) = \frac{ch}{2 π} ∮ ∮ {e}^{\frac{2 pr}{V}} ( \frac{1}{{r}^{4}} + \frac{p}{{Vr}^{3}} ) dS \qquad ( 1 )$$

In the above formula, x, y and z are coordinates of a reflection/diffraction point with a unit of m, t is seismic wave propagation time with a unit of s, h is a vertical depth of the point with a unit of m, c is an amplitude of seismic wavelet with a unit of m/s, p is a Raplace variant, V is a seismic speed with a unit of m/s, r is a distance from a seismic excitation point to the reflection/diffraction point with a unit of m, S is a reflection interface where the reflection/diffraction point is located at;

Step 2): dividing response at the point to be reflection wave response and diffraction wave response according to a position of a reflection interface:

$$ϕ ( x , y , z , t ) = \frac{ch}{4 π} ∮ \frac{1}{{ξ}^{2}} {e}^{\frac{2 p ξ}{V}} d θ + \frac{c}{2 h} {e}^{\frac{2 ph}{V}} - \frac{ch}{4 π} ∮ \frac{1}{{ξ}^{2}} {e}^{\frac{2 p ξ}{V}} d θ \qquad ( 2 )$$

wherein, θ is an included angle between the reflection point and the ground, ζ is a broad sense definition from the excitation point to the reflection/diffraction point with a unit of m;

Step 3): obtaining a seismic response equation of any point on the ground according to the reflection wave response and the diffraction wave response:

$$F ( f , x ) = \frac{c}{2 h} {e}^{- j 2 π f \frac{2 h}{V}} \{ 1 - [ 1 - {( \frac{x}{h} )}^{2} ] [ cos ( 2 π \frac{{fx}^{2}}{Vh} ) - j sin ( 2 π \frac{{fx}^{2}}{Vh} ) ] \} \qquad ( 3 )$$

In the above formula, f is a basic frequency of seismic wavelet with a unit of Hz and j is an imaginary unit.

Further, the selection method of array method of observation system, wherein the step S102 comprises:

(1) A biggest array length shall be close to the depth of the destination layer, and shall satisfy:

[symbol]

In the above formula, s is an indefinitely small number.

(2) The biggest array length shall satisfy requirements on velocity analysis accuracy, that is:

$$x \geq \sqrt{\frac{2 hV}{f}} \qquad ( 5 )$$

(3) Normal moveout correction is not bigger than 12.5%, therefore, the array length shall be smaller than a one-way route from the seismic wave to the target layer, that is:

$$κ = \frac{{x}^{2}}{2 {t}_{0}^{2} {v}^{2}} \leq 12.5 \% \qquad ( 6 )$$

In the above formula, k is a coefficient of normal moveout correction;

(4) Reflected energy and AVO accuracy shall be considered.

Further, the selection method of array length of observation system as defined above, wherein the step S103 comprises:

By analyzing the equation (3), when a target offset responds, a smallest value of the equation shall be equal to or bigger than 0, at this time, the following formula shall be satisfied:

$$1 - [ 1 - {( \frac{x}{h} )}^{2} ] \geq 0 \qquad ( 7 )$$

Substituting the equation (5) into the target equation (3):

$$F = [ \frac{c}{2 h} - \frac{c}{2 h} {e}^{- 4 π} ( 1 - \frac{2 V}{hf} ) ] {e}^{- j 2 π f \frac{2 h}{V}} \qquad ( 8 )$$

That is, amplitude response is an exponential equation correlating to a main frequency of the seismic wavelet, the depth of the destination layer and the velocity with the amplitude being positive, the amplitude is always bigger than 0 and the accuracy of velocity analysis is satisfied;

Substituting the equation (6) into the target equation (3):

$$F ( f , x ) = \frac{c}{2 h} {e}^{- j 2 π f \frac{2 h}{V}} \{ 1 - [ 1 - {( \frac{{t}_{0} v}{2 h} )}^{2} ] {e}^{- 2 π \frac{f}{Vh} \frac{{t}_{0}^{2} {v}^{2}}{4}} \} \qquad ( 9 )$$

As t₀v<2h, F(f,x)>0, requirements on normal moveout correction are satisfied; When an angle of incidence is smaller than a critical angle at the reflection interface, reflected energy is stable, in the meanwhile, in consideration of the requirements to satisfy AVO analysis accuracy, the angle of incidence is 40°.

Compared with the prior art, the present invention has the following technical effects: The selection method of the array length of the observation system based on wave propagation theories is provided in the present invention. According to Hyugens' Principle on wave propagation, each point of the wavefront is the center of a new source of a new wavefield, in this case, primary, secondary and subsequent wave sources can be defined, and quantitative analysis can be conducted. Furthermore, according to the reciprocal theory, reciprocating the seismic response at the target source with the primary seismic source, the efficient response of the target layer in an ideal observation system is formed. At this time, the Fresnel volume in the present observation system can be obtained, and imaging requirements can be satisfied. By the above analysis, in combination with the trigonometric relation as shown in FIG. 1, it is concluded that the optimum array length at the target layer shall be \sqrt{2} times the depth of the target layer.

The selection method proposed in the present invention has comprehensively considered the depth of the destination layer, satisfied the accuracy of velocity analysis, requirements on normal moveout correction and requirements for promising stability of the reflection coefficient. Compared with the conventional parameter demonstration method, the demonstration method of the array length as proposed in the present invention has the advantages of higher accuracy and applicability for destination layers. It has important significance in high-resolution, high signal-to-noise ratio three-dimensional marine seismic exploration.

### BRIEF DESCRIPTION OF DRAWINGS

FIG. 1 is a diagram showing wavefield characteristics;

FIG. 2 is a diagram showing conducting quantitative analysis of seismic response according to the seismic diffraction theory;

FIG. 3 is a flowchart diagram showing a selection method of the array length of the observation system based on wave propagation theory according to the present invention.

### EMBODIMENTS

To make purposes, technical solutions and advantages of the present invention more straightforward, a complete and precise description will be given to embodiments of the present invention, the embodiments given here are only some of the embodiments of the present invention rather than all. Based on the embodiments in the present invention, all other embodiments obtained by those of ordinary skill in the art without paying creative effort shall fall into the protection scope of the present invention.

The present invention provides a selection method for the optimum array length of the observation system at the destination layer based on wave propagation theory. The method to determine the optimum array length of the observation system at the destination layer provides a seismic wavelet excited at any point on the ground to propagate as per the spherical wavefield propagation method.

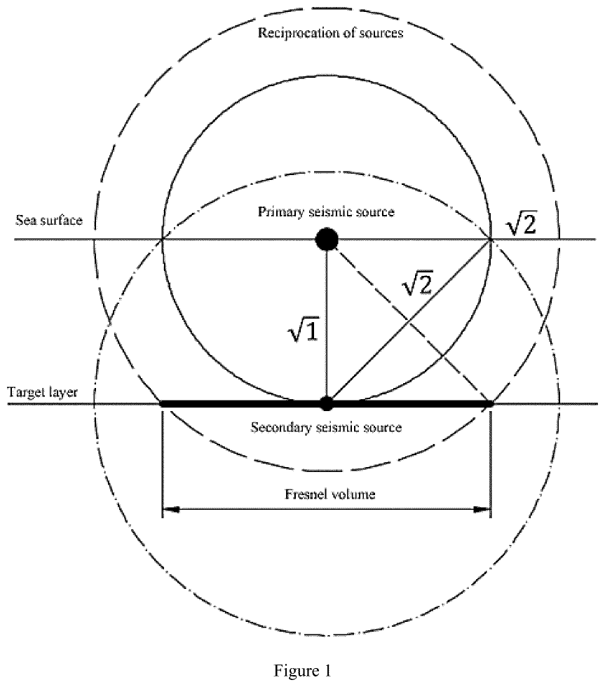

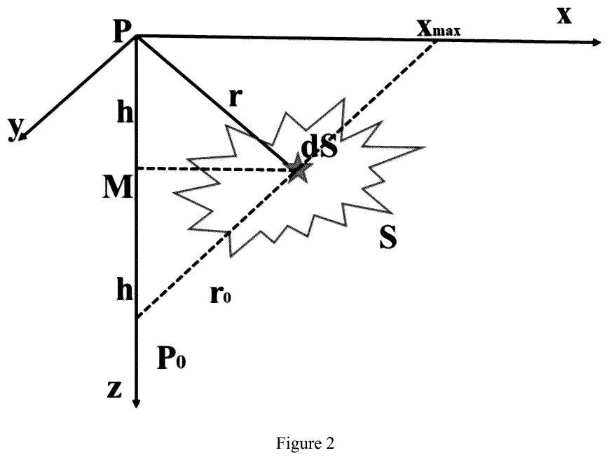

In the present embodiment, based on the Hyngens' Principle, any point in the spherical field can be the source of a new wavefields and in this way, primary, secondary and subsequent seismic sources can be defined, and the wavefield characteristics are shown in FIG. 1, propagation of the wave at the sources and reflection from the destination layer complies with solid lines and dash dot line relationships as shown in FIG. 1, that is, a radius of the wave excited by the primary seismic source is a distance 1 from the primary seismic source to the reflection point, according to the Hyugens' Principle, the secondary seismic source will be formed at the reflection point at the target layer, and a radius of the wave excited by the secondary seismic source will be \sqrt{2} times of a distance from the primary seismic source to the reflection point. According to the reciprocal principle, reciprocating the seismic response at the target layer with the primary seismic source, the efficient seismic response at the target layer in an ideal observation system is formed, that is, the dashed lines as shown in FIG. 1. At this time, Fresnel volume in the present observation system is formed, that is, the bold lines in FIG. 1. As per seismic diffraction theory quantitative analysis is given to the efficient seismic response at the target layer in the ideal observation system as shown in FIG. 1, and a seismic response expression of any point on the ground is obtained, as shown in FIG. 2. According to the wavefield characteristics as shown in FIG. 1, taking into consideration the depth of the destination layer, to satisfy requirements on velocity analysis accuracy (5%), satisfy requirements on normal moveout correction (12.5%) and stable reflection coefficient, and by deep analysis of the seismic response equation of any point on the ground as per step 3 the optimum array length of the observation system can be determined.

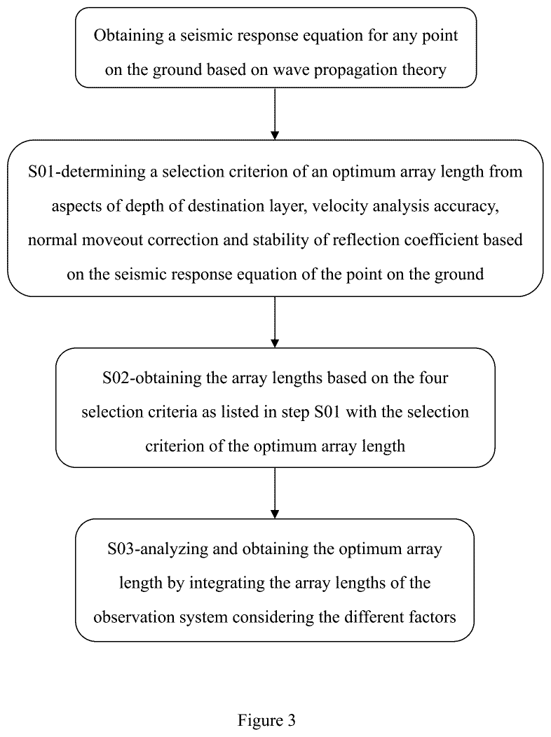

As shown in FIG. 3, an embodiment of the present invention provides a selection method of array length of observation system based on wave propagation theory, comprising the following steps:

Step S101: obtaining a seismic response equation of any point on the ground according to the wavefield propagation theory;

Specifically, obtaining the seismic response equation comprises the following steps: Step 1: seismic waves are excited by air-gun in the seawater, after being reflected or diffracted by a point underground, and are transmitted to receiving tugboats. According to seismic diffraction theory, the seismic response at the point can be analyzed quantitatively. According to the wavefield characteristics obtained from the foregoing analysis, the biggest array length can be obtained.

The seismic response of a point in a horizontal direction is:

$$ϕ ( x , y , z , t ) = \frac{ch}{2 π} ∮ ∮ {e}^{\frac{2 pr}{V}} ( \frac{1}{{r}^{4}} + \frac{p}{{Vr}^{3}} ) dS \qquad ( 1 )$$

In the above equation, x, y, and z are coordinates of any reflection/diffraction point with a unit of m, t is the propagation time of the seismic wave with a unit of s, h is the vertical depth of the point with a unit of m, c is an amplitude of the seismic wavelet with a unit of m/s, p is a Laplace variable, V is a velocity of the seismic wave with a unit of m/s, r is a distance from an excitation point to the reflection/diffraction point with a unit of m, and S is a reflection interface that the reflection point is located at.

Step 2, according to the position of the reflection interface, separating response at this point to be reflection point response and diffraction point response:

$$ϕ ( x , y , z , t ) = \frac{ch}{4 π} ∮ \frac{1}{{ξ}^{2}} \text{?} d θ + \frac{c}{2 h} \text{?} - \frac{ch}{4 π} ∮ \frac{1}{{ξ}^{2}} \text{?} d θ \qquad ( 2 )$$

$$\text{?} \text{indicates text missing or illegible when filed}$$

wherein, θ is an included angle between the reflection point and the ground, and ζ is a broad sense definition of the distance from the excitation point to the reflection/diffraction point with a unit of m.

Step 3, after deduction, it is known that the seismic response at any position on the ground is:

$$F ( f , x ) = \frac{c}{2 h} \text{?} \{ 1 - [ 1 - {( \frac{x}{h} )}^{2} ] [ cos ( 2 π \frac{{fx}^{2}}{Vh} ) - j sin ( 2 π \frac{{fx}^{2}}{Vh} ) ] \} \qquad ( 3 )$$

$$\text{?} \text{indicates text missing or illegible when filed}$$

In the above equation, f is the basic frequency of the seismic wavelet with a unit of Hz and j is an imaginary unit.

That is, according to Hyugens' Principle, by analysis of propagation of the wavefield, features of seismic signals at any point on the ground can be known, and the features are related to the depth of the destination layer where the underground medium is located, interval velocity, the basic frequency of the wavelet that excites the seismic wave and amplitude. According to the foregoing equation, all factors can be integrated for consideration and the optimum array length can be calculated, which is more profound and detailed.

Step S102: from the seismic response equation, determination selection criteria of the optimum array length from different factors; wherein the different factors comprise: depth of the destination layer, velocity analysis accuracy, normal moveout correction, reflected energy and AVO accuracy.

Specifically, determining the optimum array length from the depth of the destination layer, velocity analysis accuracy, normal moveout correction and stable reflection coefficient, comprises specifically:
(1) The biggest array length shall be close to the depth of the destination layer, and satisfy:

[symbol]

In the above equation, ε is any number that is arbitrarily small.
(2) The biggest array length shall satisfy the requirements on velocity analysis accuracy, that is:

$$x \geq \sqrt{\frac{2 hV}{f}} \qquad ( 5 )$$

(3) The normal moveout correction shall be not bigger than 12.5%, that is, the array length shall be smaller than a one-way route for the seismic wave to reach the destination layer, that is:

$$κ = \frac{{x}^{2}}{2 {t}_{0}^{2} {v}^{2}} \leq 12.5 \% \qquad ( 6 )$$

wherein, k is the coefficient of the normal moveout correction.
(4) Considering the reflected energy and AVO accuracy. Step 103: utilizing the selection criteria of the optimum array length, obtaining the array lengths according to different considering factors;

Utilizing the selection criteria of the optimum array length, deducting and analyzing the seismic response equation (equation 3) of any point on the ground, and obtaining the array lengths based on the four selection criteria in step S102, respectively: By analyzing equation (3), it can be known that when the target offset responds, the smallest value of the equation shall be equal to or bigger than 0, at this time, the following equation shall be satisfied:

$$1 - [ 1 - {( \frac{x}{h} )}^{2} ] \geq 0 \qquad ( 7 )$$

Substituting the equation in the inequality (5) so:

$$F = [ \frac{c}{2 h} - \frac{c}{2 h} \text{?} ( 1 - \frac{2 V}{hf} ) ] \text{?} \qquad ( 8 )$$

$$\text{?} \text{indicates text missing or illegible when filed}$$

That is, amplitude response is an exponential function correlating to the main frequency of the wavelet, the depth of the destination layer and the velocity, and the amplitude response is always bigger than 0 and satisfies requirements on velocity analysis accuracy.

Substituting the equation (6) into the target equation (3):

$$F ( f , x ) = \frac{c}{2 h} \text{?} \{ 1 - [ 1 - {( \frac{{t}_{0} v}{2 h} )}^{2} ] \text{?} \} \qquad ( 9 )$$

$$\text{?} \text{indicates text missing or illegible when filed}$$

As t₀v>2h, F(f,x)>0, requirements on normal moveout correction are satisfied. When the incident angle at the reflection interface is smaller than the critical angle, reflected energy is stable, in the meantime, taking into consideration requirements to promise AVO analysis accuracy, the incident angle shall be 40°. Step S104: given all the array lengths according to different considering factors, determining that the optimum array length is \sqrt{2} times the depth of the destination layer. Comprehensively considering all the above factors, finally it is determined that the optimum array length of the observation system is \sqrt{2} times the depth of the destination layer, in the present invention, the optimum array length is obtained by analyzing the wavefield characteristics based on Hyugens' Principle, that is, every point shall be regarded as a new seismic source for propagation, therefore, requirements of high resolution high signal-to-noise-ratio seismic acquisition system can be met.

Specifically, first of all, by the Hyugens' Principle and the principle of Reciprocity of seismic sources, the wavefield characteristics of the seismic sources are obtained. As shown in FIG. 1, according to the wavefield propagation theory and trigonometrical function relationship, the distance from the primary seismic source to the destination layer is 1, the radius of the wavefield formed by the secondary seismic source is \sqrt{2} times the distance from the primary seismic source and the destination layer, according to the principle of reciprocity, a reciprocal seismic source of the secondary seismic source exists at the primary seismic source, and a radius of the reciprocal seismic source is \sqrt{2} times the distance from the primary seismic source to the destination layer, and the radius can be used as the optimum array length targeting at the destination layer. Thereafter conducting quantitative analysis of the wavefield characteristics according to the seismic diffraction theory and the expression of seismic response at any point on the ground can be obtained. Finally, analyzing the expression of the seismic response from the perspective of velocity analysis accuracy, normal moveout correction and AVO, it is concluded that the array length at the destination layer complies with the optimum array length of the destination layer calculated based on wave propagation theory.

Finally it shall be noted that: the above embodiments are only intended to explain the technical solutions of the present invention rather than limit the same; although detailed description has been given to the present invention concerning the previous embodiments, those of ordinary skill in the art shall appreciate that: it is still possible to modify the technical solutions recited in the present invention or replace some technical features in the present invention with equivalent parts, and all the modifications and equivalent replacements do not deviate the essence of the technical solutions from the spirit and scope of the technical solutions of the embodiments of the present invention.

1. (canceled)

2. A selection method of array length of observation system, comprising the following steps:
step S101: obtaining a seismic response equation for any point on ground based on a wave field propagation theory;
step S102: determining at least one selection criterion of an optimum array length considering different factors according to the seismic response equation;
wherein the different factors comprise: a depth of a destination layer, velocity analysis accuracy, normal moveout correction, reflected energy and amplitude variations with offset (AVO) accuracy;
step S103: obtaining the array lengths considering the different factors respectively according to the at least one selection criterion of the optimum array length; and
step S104: integrating the array lengths considering the different factors and determining that the optimum array length is \sqrt{2} times the depth of the destination layer;
wherein the step S101 comprises:
step 1): given that seismic waves are excited in seawater by air guns, and are transmitted to a receiving tugboat after being reflected or diffracted by an underground point, by conducting quantitative analysis of seismic response of the underground point with seismic diffraction theory, then:
seismic response of the underground in a horizontal direction is:
$$ϕ ( x , y , z , t ) = \frac{ch}{2 π} ∯ \text{?} ( \frac{1}{{r}^{4}} + \frac{p}{{Vr}^{3}} ) dS \qquad ( 1 )$$
$$\text{?} \text{indicates text missing or illegible when filed}$$
wherein, x, y and z are coordinates of a reflection/diffraction point with a unit of m, t is seismic wave propagation time with a unit of s, and h is a vertical depth of the point with a unit of m, c is an amplitude of seismic wavelet with a unit of m/s, p is a Raplace variant, V is a seismic speed with a unit of m/s, r is a distance from a seismic excitation point to the reflection/diffraction point with a unit of m, S is a reflection interface where the reflection/diffraction point is located at;
step 2): dividing response at the point to be reflection wave response and diffraction wave response according to a position of a reflection interface:
$$ϕ ( x , y , z , t ) = \frac{ch}{4 π} ∮ \frac{1}{{ξ}^{2}} \text{?} d θ + \frac{c}{2 h} \text{?} - \frac{ch}{4 π} ∮ \frac{1}{{ξ}^{2}} \text{?} d θ \qquad ( 2 )$$
$$\text{?} \text{indicates text missing or illegible when filed}$$
in the equation, θ is an included angle between the reflection point and the ground, ζ is a broad sense definition from the excitation point to the reflection/diffraction point with a unit of m;
step 3): obtaining a seismic response equation of any point on the ground according to the reflection wave response and the diffraction wave response:
$$F ( f , x ) = \frac{c}{2 h} {e}^{- j 2 π f \frac{2 h}{V}} \{ 1 - [ 1 - {( \frac{x}{h} )}^{2} ] [ cos ( 2 π \frac{{fx}^{2}}{Vh} ) - j sin ( 2 π \frac{{fx}^{2}}{Vh} ) ] ) \qquad ( 3 )$$
where f is a basic frequency of seismic wavelet with a unit of Hz and j is an imaginary unit.

3. The selection method of array length of observation system according to claim 2, wherein the step S102 comprises:
(1) a biggest array length shall be close to the depth of the destination layer, and shall satisfy: [symbol]
in the equation, ε is an indefinitely small number;
(2) the biggest array length shall satisfy requirements on velocity analysis accuracy, that is:
$$x \geq \sqrt{\frac{2 hV}{f}} \qquad ( 5 )$$
(3) normal moveout correction is not bigger than 12.5%, therefore, the array length shall be smaller than a one-way wavepath from the seismic wave to the target layer, that is:
$$κ = \frac{{x}^{2}}{2 {t}_{0}^{2} {v}^{2}} \leq 12.5 \% \qquad ( 6 )$$
in the equation, k is a coefficient of normal moveout correction;
(4) reflected energy and AVO accuracy shall be considered.

4. The selection method of array length of observation system according to claim 3, wherein the step S103 comprises:
by analyzing the equation (3), when a target offset responds, a smallest value of the equation shall be equal to or bigger than 0, at this time, the following formula shall be satisfied:
$$1 - [ 1 - {( \frac{x}{h} )}^{2} ] \geq 0 \qquad ( 7 )$$
substituting the equation (5) into the target equation (3):
$$F = [ \frac{c}{2 h} - \frac{c}{2 h} \text{?} ( 1 - \frac{2 V}{hf} ) ] \text{?} \qquad ( 8 )$$
$$\text{?} \text{indicates text missing or illegible when filed}$$
that is, amplitude response is an exponential equation correlating to a main frequency of the seismic wavelet, the depth of the destination layer and the velocity with the amplitude being positive, the amplitude is always bigger than 0 and accuracy of velocity analysis is satisfied; substituting the equation (6) into the target equation (3):
$$F ( f , x ) = \frac{c}{2 h} \text{?} \{ 1 - [ 1 - {( \frac{{t}_{0} v}{2 h} )}^{2} ] \text{?} \} \qquad ( 9 )$$
$$\text{?} \text{indicates text missing or illegible when filed}$$
as t₀v<2h, F(f,x)>0, requirements on normal moveout correction are satisfied;
when an angle of incidence is smaller than a critical angle at the reflection interface, reflected energy is stable, meantime, in consideration of the requirements to satisfy AVO analysis accuracy, the angle of incidence is 40°.
